(19) United States
(12) Patent Application Publication
(10) Pub. No.: US 2004/0152050 A1
(43) Pub. Date: Aug. 5, 2004

(54) Conformable dental tray

(76) Inventor: Robert Ibsen, Santa Maria, CA (US)

Correspondence Address: Law Offices of John S. Munday, PO BOX 423, Isanti, MN, 55040, US

(21) Appl. No.: 10/336,077

(22) Filed: Jan. 3, 2003

(51) Int. Cl. A61C 5/00

(52) U.S. Cl. 433/215

(57) ABSTRACT

A conformable dental tray having an upper tray and a lower tray joined together at a hinge portion. The upper lower trays may have a generally U-shaped configuration and are adapted to hold treating agents, such as teeth whitening bleaching agents, against a patient's teeth. The upper tray, lower tray and hinge portion are formed from a flexible material. At least one notch is formed on at least one of the upper tray and lower tray, the notch being adapted to permit the tray to bend to conform to the arch of a patient's teeth. Preferred trays have a plurality of arc-shaped outwardly extending portions separated by inwardly extending arcs for conforming contact between the teeth with a treating agent to give a uniform contact of the treatment.

### FIELD OF THE INVENTION

The present invention relates to dental trays used for treatments such as bleaching and the like. More particularly, the present invention relates to a conformable dental tray that is adjustable to accommodate or conform to different sized patients, such as those with narrow arches.

### BACKGROUND OF THE INVENTION

Dental trays are receptacles that are used to carry a medicine or dental hygiene materials, such as bleaching agents or fluoride application, and apply them to the teeth. It confines the material next to the teeth during the application. Bleaching is becoming more popular with the general public because efforts have been made to simplify the bleaching process and provide devices useful for home care and treatment by individuals without professional supervision.

There are two types of dental trays: stock and customized. Stock trays are pre-fabricated into a variety of standard sizes. They are used only for preliminary procedures and to produce impressions for casting as an interim step to creating more accurate dental trays and models of teeth. Custom trays are made by a dentist or technician by molding a material over a gypsum model of the patient's teeth. In order to get the gypsum model, a preliminary impression is made from the patient's teeth. The model requires at least one dental visit and requires a laboratory to construct the gypsum model.

Once the model is made, the customized dental tray is formed by the dentist or lab according to the limitations of the materials to be used for the tray. If the tray is made of thermoplastic sheets, the tray may be formed in a vacuum forming machine or other machine which exerts pressure. The sheets are placed in a soft state over the model and pressure is applied while the material sets.

Attempts have also been made to design simpler devices for use by the patient at home. Tarvis U.S. Pat. No. 5,340,314 discloses the simplest use of dental wax, where the flat wax 14 in FIG. 2 is rolled to fit the shape of a dental plate. No suggestion of any use other than to take impressions is made in this patent. Sintov et al U.S. Pat. No. 5,425,953 discloses a liquid polymer that includes a bleaching agent or other treatment agent. There is no reference to dental wax in Sintov et al. Curtis et al U.S. Pat. No. 5,639,445 employs a dilatant silicone polymer composition that is shaped and pressed against the teeth for sufficient time to release the active component. The polymer in Curtis et al is elastic, putty-like in composition, and is primarily directed at removing food particles from between the teeth and/or applying a dentifrice or medicament to below the gum line. Yarborough U.S. Pat. No. 5,713,738 employs laser light to activate bleaching agents applied to the teeth.

Latex rubber is used to cover the mouth other than the teeth.

Sagel et al U.S. Pat. No. 5,879,691 (Sagel '691) covers a delivery system using a strip of material having a low flexural stiffness. The material is generally characterized as being thin, having a flexural stiffness less than a predetermined value, readily conformable without permanent deformation, and having some adhesive properties. The preferred material is a gel and the specific preferred gel is formed from 70% glycerin, 5% carboxypolymethylene, 10% carbamide peroxide and 15% water. The material is very soft, almost mushy, and is different in kind from the dental wax which fractures when bent quickly at room temperature.

Sagel et al U.S. Pat. No. 5,891,453 (Sagel '453) discloses an improvement on Sagel '691, in which the strip of material is any number of materials, both synthetic and natural, and would broadly include dental wax if that material, not disclosed, was as flexible as called for by the patent. The clear plastic flexible material on to which the gel is placed is much more flexible than dental wax.

Finally, Sagel et al U.S. Pat. No. 5,894,017 (Sagel '017) discloses the same flexible material with a substance on it for treating teeth. This patent calls for the substance to additionally provide an adhesive attachment between the strip and the surface to hold the delivery system in place. Treatment agent 14 in FIG. 1 is an illustration of one adhesive agent.

All three Sagel et al patents provide for covering the front of the teeth but do not have a configuration suitable for covering the back of the teeth.

Another form of stock dental tray is a hinged tray with a U-shaped component for the upper teeth and a second U-shaped component for the lower teeth, with both components joined by a flexible portion that is bent so that both the U-shaped components engage the teeth of the patient. The hinged tray is made from flexible plastic that is safe for use in contact with a patient and is suitable to hold bleaching solutions and the like without reacting therewith. The problem with this form of tray is that a large number of sizes must be kept in stock to fit the wide variety of patients coming in to the dental offices. In actuality it is often difficult to find the right size so that a comfortable is achieved since the tray may be close to a good fit yet still give the patients some discomfort. It would be a great advance in the dental art if

One embodiment of the present invention is a dental tray that is hinged to allow it to enclose both the upper and lower teeth at one time, while adjusting for the variation in the patient's mouth size.

Another embodiment is a dental tray that is adjustable to accommodate or conform to different sized patients, such as those with narrow arches.

Other embodiments will appear hereinafter.

### SUMMARY OF THE INVENTION

The present invention is a conformable dental tray formed from a single piece of inert, flexible plastic such as polyethlyene, polypropylene, ethylene vinyl acetate and the like. Any conventional plastic or other material normally used in dental treatments, particularly those formed into trays, may be used in this invention. All that is required of the material is that it be inert to both the treatment and to the patient, and that it have sufficient flexibility to function as described below to provide a conformable tray. The present invention is intended to be used in any application where a tray is inserted into a patient's mouth for any treatment for any condition.

The tray has a first portion intended to enclose the upper teeth and a second portion intended to enclose the lower teeth of a patient. A strip of the same material bridges the two tray portions and is sufficiently flexible to permit the trays to engage the both upper and lower teeth of a patient at the same time.

The trays are generally U-shaped and are configured to surround the teeth to be treated. It is contemplated that various trays will be configured to treat some or all of the teeth, depending on the treatment planned. At the present time, the present invention is intended to be used as a bleaching tray for whitening teeth, essentially all other treating agents are also contemplated for use by the present invention without limitation.

The present conformable dental tray of this invention includes at least one notch in either the upper or lower tray, or both, to permit the tray to engage a variety of arch sizes and substantially reduce the need for a large inventory of different sized trays. It also permits adjustment of the upper and lower trays separately when that is required for a well functioning fit.

In the preferred embodiment, the upper and lower trays will each have a pair of notches located on the inside of the respective trays and spaced from the tray ends and from the center by an approximately equal distance, to give the tray the maximum flexibility to adjust to the widest range of arch sizes. More that two notches are used on either tray, of course, but the increase in flexibility is not significantly greater than with the preferred two notches.

When the tray is used, the bridge material portion tends to maintain the trays in position once they have been conformed to the patient since the bridge portion functions as a biasing force. Also, the viscosity of some treating solutions may be sufficient to additionally maintain the trays in the intended position for treatment.

### BRIEF DESCRIPTION OF THE DRAWINGS

For a more complete understanding of the invention, reference is hereby made to the drawings, in which:

FIG. 1 is a plan view of the preferred embodiment, with a person's teeth illustrated for size, illustrated in the open position;

FIG. 2 is a side elevational view taken along line 2-2 of FIG. 1;

FIG. 3 is a front elevational view taken along line 3-3 of FIG. 1; FIG. 4 is a sectional view taken along line 4-4 of FIG. 1;

FIG. 5 is a sectional view taken along line 5-5 of FIG. 1; and

FIG. 6 is a sectional view taken along line 6-6 of FIG. 1;

### DETAILED DESCRIPTION OF THE INVENTION

An important element of the invention is the use of a dental tray which is generally U-shaped and configured for teeth whitening treatments such as bleaching and the like. It is flexible enough to conform to the patient's upper and lower teeth in close proximity to the teeth to cause the treating agent to contact the teeth and perform its intended function.

As shown in the drawings, the tray, 10 generally, includes an upper tray 11 and a lower tray 13, connected by bridges 15 and 17. Both upper tray and lower tray 13 are generally U-shaped, with that term being intended to include any such shape that forms a bottom and two sides for engagement with a patient's teeth. In a preferred embodiment, at least the front of the U-shaped trays have a plurality of arc-shaped bulges or outwardly extending portions 21 divided or separated by inwardly extending arcs 23. Arcs 21 and 23 provide an inner surface of the tray that permits a closer fitting contact between the teeth and the spaces between them with the tray or treating agent contained in the tray. This ensures that the treating agent, such as, for example, a bleaching solution, is applied to all of the teeth to give an uniform application and contact.

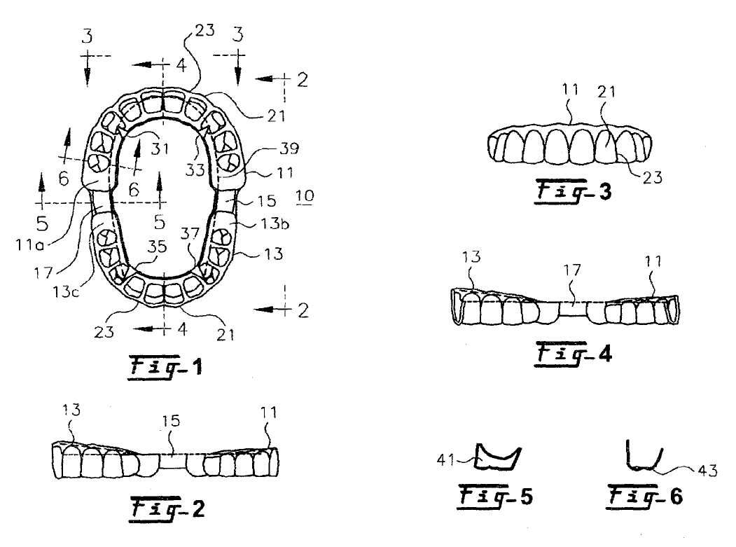

The bridges 15 and 17 are flexible so that the upper tray 11 and lower tray 13 can be bent such that the two trays 11, 13 are in position to be inserted into the patient's mouth and make contact with the upper and lower teeth respectively. Upper tray 11 includes two notches, 31 and 33, while lower tray 13 includes two similar notches 35 and 37, as shown in FIG. 1. Trays 11 and 13 are shown for illustrative purposes as part of the invention. Other shapes and configurations of the trays are also within the scope of this invention.

As can be appreciated, the ends 11a and 11b of upper tray 11 can be moved closer to each other, or further apart, because the upper tray 11 is flexible because of notches 31 and 33. Similarly, the ends 13a and 13b of lower tray 13 can be moved closer to each other, or further apart, because the lower tray 13 is flexible because of notches 35 and 37. Dotted line 39 indicates the arc of the upper tray 13, and movement of ends 11a and 11b will change arc 39.

As has been noted above, the tray of this invention may be made from a variety of conventional materials regularly used in flexible dental tray devices. If desired, the upper and lower trays 11 and 13 respectively may be made of one material and the bridge sections 15 and 17 of another material that provides a biasing force toward unbending the hinge action, to further assist in maintaining the trays against the teeth during treatment. Viscous treating agents such as semi-fluid bleaching compositions also may assist in maintaining the trays in their desired positions.

In FIG. 5, the shape of the upper tray bridge portion 15 is seen, showing a thickness 41 that is much greater than the thickness of 43 the U-shaped portion of tray 11 shown in FIG. 6. This thickness permits flexing of the bridge portions 15 and 17 without concern for weakening the tray device, so it can be used for a large number of treatments over a long period of time. The depth of U-shaped tray 11 due to thickness 43 allows for a sufficient quantity of treating agent to be employed to effectively brighten the patient's teeth.

As can be seen in FIG. 1, upper tray 11 has two notches 31 and 33 and lower tray 13 also has two notches 35 and 37, and all the notches are located at the place along arc 39 that permits the greatest amount of movement by ends 11a and 11b as well as ends 13a and 13b. Notches 31, 33, 35 and 37 are preferably located at a position approximately equidistant from the ends 11a, 11b, 13a, and 13b, respectively and the centers 11c and 13c of upper and lower trays 11 and 13. Other locations are permitted but this orientation of these notches as shown in FIG. 1 is preferred.

The tray is now ready for use. While particular embodiments of the present invention have been illustrated and described, it is not intended to limit the invention, except as defined by the following claims.

1. A conformable dental tray, comprising:
an upper tray and a lower tray joined together at a hinge portion, said upper tray and lower tray being adapted to hold treating agents against a patient's teeth, said upper tray, lower tray and hinge portion being formed from a flexible material; and
at least one notch on at least one of said upper tray and lower tray, said notch being adapted to permit said at least one tray to bend to conform to the arch of a patient's teeth.

2. The tray of claim 1, wherein said upper and lower trays have a generally U-shaped configuration and the treating agent is a teeth whitening bleaching agent.

3. The tray of claim 1, wherein sad upper and lower trays both have at least one notch.

4. The tray of claim 1, wherein at least the front of at least one of said upper tray and lower tray has a plurality of arc-shaped outwardly extending portions separated by inwardly extending arcs to provide an inner surface of the tray for conforming contact between the teeth and the spaces between them with a treating agent contained in at least one of said trays to give a uniform contact of the treatment.

5. The tray of claim 1, wherein said hinge portion is sufficiently flexible to permit the upper tray and lower tray to be bent such that the two trays are in position to be inserted into the patient's mouth and make contact with the upper and lower teeth respectively.

6. The tray of claim 5, wherein said bridge portion provides a biasing force toward unbending the hinge action, to assist in maintaining the trays against the teeth during treatment.

7. The tray of claim 1, wherein said bridge portion has a thickness greater than the thickness of U-shaped portion of said trays, thereby permitting flexing of the bridge portions without weakening the tray device. to permit multiple reuses thereof.

8. The tray of claim 1, wherein said upper and lower trays each have a pair of spaced notches, each said notch being located about half the distance from the end of each tray and its center.

9. A conformable dental tray, comprising:
upper tray means and lower tray means for holding treating agents against a patient's teeth,
hinge means for joining said upper and lower tray means, said upper tray means, lower tray means and hinge portion means being formed from a flexible material; and
at least one notch on at least one of said upper tray and lower tray means, said notch being adapted to permit said at least one tray means to bend to conform to the arch of a patient's teeth.

10. The tray of claim 9, wherein said upper tray means and lower tray means have a generally U-shaped configuration and the treating agent is a teeth whitening bleaching agent.

11. The tray of claim 9, wherein sad upper and lower tray means both have at least one notch.

12. The tray of claim 9, wherein at least the front of at least one of said upper tray means and lower tray means has a plurality of arc-shaped outwardly extending portions separated by inwardly extending arcs to provide an inner surface of the tray means for conforming contact between the teeth and the spaces between them with a treating agent contained in at least one of said tray means to give a uniform contact of the treatment.

13. The tray of claim 9, wherein said hinge portion means is sufficiently flexible to permit the upper tray and lower tray means to be bent such that the two tray means are in position to be inserted into the patient's mouth and make contact with the upper and lower teeth respectively.

14. The tray of claim 13, wherein said bridge portion means provides a biasing force toward unbending the hinge action, to assist in maintaining the tray means against the teeth during treatment.

15. The tray of claim 9, wherein said bridge portion means has a thickness greater than the thickness of U-shaped portion of said tray means, thereby permitting flexing of the bridge portion means without weakening the device. to permit multiple reuses thereof.

16. The tray of claim 9, wherein said upper and lower trays each have a pair of spaced notches, each said notch being located about half the distance from the end of each tray and its center.

17. A conformable dental tray, comprising:
an upper tray and a lower tray joined together at a hinge portion, said upper tray and lower tray having a generally U-shaped configuration and being adapted to hold treating agents against a patient's teeth, said upper tray, lower tray and hinge portion being formed from a flexible material;
a pair of spaced notches on said upper tray and lower trays, said notch being adapted to permit said at least one tray to bend to conform to the arch of a patient's teeth; and
the front of at said upper tray and lower tray having a plurality of arc-shaped outwardly extending portions separated by inwardly extending arcs to provide an inner surface of the tray for conforming contact between the teeth and the spaces between them with a treating agent contained in at least one of said trays to give a uniform contact of the treatment.

18. The tray of claim 17, wherein the treating agent is a teeth whitening bleaching agent.

19. The tray of claim 17, wherein said hinge portion is sufficiently flexible to permit the upper tray and lower tray to be bent such that the two trays are in position to be inserted into the patient's mouth and make contact with the upper and lower teeth respectively.

20. The tray of claim 17, wherein said bridge portion has a thickness greater than the thickness of U-shaped portion of said trays, thereby permitting flexing of the bridge portions without weakening the tray device. to permit multiple reuses thereof.
